(19) United States
(12) Patent Application Publication
(10) Pub. No.: US 2005/0144041 A1
(43) Pub. Date: Jun. 30, 2005

(54) Method of matching seasonal vaccine supply with seasonal demand using a consumer-driven, pre-production, vaccine reservation system

(76) Inventors: John Raymond Essig JR., Fairfax, VA (US); James Michael Essig, Fairfax, VA (US); Maryanne Evelyn Essig, Fairfax, VA (US)

Correspondence Address: John Raymond ESSIG Jr., P.O. BOX 3333, FAIRFAX, VA, 22038-3333, US

(21) Appl. No.: 11/018,479

(22) Filed: Dec. 21, 2004

Related U.S. Application Data
(60) Provisional application No. 60/531,705, filed on Dec. 21, 2003.

(51) Int. Cl. G06F 17/60

(52) U.S. Cl. 705/2

(57) ABSTRACT

An automated, consumer-driven, pre-production, seasonal vaccine reservation system for facilitating the efficient production, distribution, and/or administration of health-critical, long-production-lead-time seasonal vaccines (or other pharmacological agents), whereby use of such a consumer-driven vaccine reservation system provides a highly effective means for substantially ensuring or guaranteeing that consumer demand for seasonal vaccine can be fully and consistently met, but without subjecting the producers of vaccine and/or other cognizant parties associated with the healthcare industry to undue financial risk. In addition to the physical elements comprising such a consumer-driven vaccine reservation system, the present invention also represents various unique business methods for accurately matching seasonal vaccine supply with seasonal consumer demand, thereby substantially facilitating production, distribution, and/or timely administration of vaccine.

### CROSS-REFERENCE TO RELATED APPLICATIONS

This application claims the benefit of U.S. Provision Patent Application Ser. No. 60/531,705, filed 21 Dec. 2003. In addition, this application hereby incorporates by reference the full subject matter of U.S. Provision Patent Application Ser. No. 60/531,705, including all subject matter contained in its Specification, claims, and Drawing.

### BACKGROUND OF THE INVENTION

1. Field of the Invention

The present invention relates most broadly to computer-based electronic business systems, which provide improved methods for accurately matching seasonal vaccine supply with seasonal consumer demand, including improved methods for managing the production, distribution, administration, and/or post-administration evaluation of seasonal vaccine (or other health-critical or life-critical pharmacological agents). More specifically, the present invention, in its preferred embodiments, relates to substantially automated, consumer-driven, pre-production, seasonal vaccine reservation systems for facilitating the efficient production, distribution, administration, and/or post-administration evaluation of health-critical, long-production-lead-time seasonal vaccines (e.g., influenza or “flu” virus vaccine), whereby use of such a consumer-driven vaccine reservation system provides an effective means for ensuring that consumer demand for seasonal vaccine can be fully and consistently met, but without subjecting the producers of vaccine, public health agencies, medical practitioners, and/or other cognizant parties within the broader healthcare industry to unnecessary financial risk.

2. Industry Background

Briefly, to meet the needs of healthcare consumers for annual or seasonal vaccines (e.g., influenza or “flu” virus vaccine), the healthcare industry along with cognizant governmental health agencies currently expend a considerable amount of time, effort, and financial resources to ensure that such annual or seasonal vaccines are generally produced and distributed in quantities sufficient to fully meet consumer demand (i.e., every person who wishes to receive a vaccine has the opportunity to do so, although often for a fee). However, the healthcare industry and the cognizant governmental health agencies also expend a considerable amount of time, effort, and financial resources to avoid the wasteful expense associated with excessive overproduction of unwanted vaccine, which, if unused during a particular season, typically must be destroyed as a result of its limited shelf life and/or obsolescence. Accordingly, healthcare industry professionals and/or government authorities are thus generally required to simultaneously meet, to the greatest extent possible, two often-competing objectives: (1) providing good health care (e.g., ensuring full access to vaccine), and (2) avoiding excessive financial expense (e.g., avoiding gross overproduction of vaccine).

To reliably meet both of these objectives, the broader healthcare industry requires an accurate method of matching seasonal vaccine supply (i.e., establishing production and/or distribution quantities) with seasonal consumer demand for vaccine. However, due in large part to the lengthy process of vaccine production, the highly variable and often fickle nature of consumer demand, and the variable and somewhat unpredictable nature of various pathogens (such as influenza virus), the healthcare industry and governmental health agencies currently experience great difficulty—and only limited success—in their yearly attempts to accurately match seasonal vaccine supply with seasonal vaccine demand.

In greater detail, first note that producers of vaccine would ideally prefer to produce vaccine based on known consumer demand during the season (e.g., the “flu” season). Unfortunately, the production-lead-time for vaccine is sufficiently long in duration (e.g., approximately four months in duration using existing mass production methods for influenza virus vaccine) such that it is not currently economically and/or temporally viable to produce vaccine based on consumer demand during the season. As a result, producers must instead attempt to accurately estimate or forecast (via educated guessing) the demand for vaccine during the upcoming season, and then commit to specific production quantities several months before actual consumer demand is known. Further, while all forecasts are generally subject to some amount of error, this particular forecasting exercise is made much more difficult by the highly variable (and often fickle) seasonal demand for vaccine, which generally fluctuates in direct response to the perceived seasonal threat by the healthcare consumer to a given pathogen or strain thereof. Difficulties in forecasting demand are further exacerbated by the fact that certain pathogens, such as influenza, tend to mutate and/or breakout regularly, yet unreliably, and with unknown severity. Further, mass-media and, more specifically, its ability to induce significant levels of hysteria within the broader population, can radically alter the demand for seasonal vaccine, long after the producers of vaccine were required to establish production quantities and commence production.

Ultimately, the current methods used to forecast seasonal vaccine demand (and, thus, establish accurate production quantities) are, in practice, as much an art as they are a science. Consequently, such forecast-based methods tend to be highly unreliable and, thus, expose both the consumers of vaccine and the producers of vaccine to considerable risks.

3. Related Art

a. Description of Prior Art

A multitude of different reservation systems exist throughout the world for various business and non-business activities; however, the related art of interest—principally in the form of current or conventional business practices within the broader healthcare industry for matching seasonal vaccine supply with seasonal vaccine demand—does not disclose the present invention.

Breifly, prior related art does provide various methods for attempting to match seasonal vaccine supply and demand. However, all such methods of prior art typically attempt to match supply and demand by estimating or forecasting future demand for seasonal vaccine (and thus establish production and/or distribution quantities for seasonal vaccine) based largely on (1) the historical consumer demand for similar vaccine during prior seasons and/or (2) the perceived or estimated relative seasonal pathogenic threat during the upcoming season.

It should be noted such prior art is principally embodied within the open literature and/or evidenced by the common knowledge of those having professional experience in a related field. Accordingly, no specific prior art references (e.g., patents and the like) are cited herein. Nonetheless, a closer review of prior art (i.e., the commonly-known conventional business practices within the healthcare industry for determining vaccine production and/or distribution quantities) clearly reveals its many limitations.

Regarding the limitations of prior art, as previously noted, any forecast-based method for matching seasonal supply of vaccine with seasonal demand (i.e., determining adequate production and-/or distribution quantities) generally entails a highly error-prone “compromise” between the two critically important, yet typically competing, simultaneous objectives of (1) ensuring full access to vaccine and (2) avoiding the expense and waste of gross overproduction. To minimize the adverse consequences of the methods of prior art, note that the associated compromise, which is typically embodied in the form of a pre-season decision or commitment to a specific production quantity, is historically intentionally biased toward a moderate amount of overproduction, so as to provide an adequate margin of safety between supply and demand.

If such competing objectives are managed successfully for a given season, only a small amount of excess vaccine is produced, thereby resulting in limited waste. Although seemingly affordable, is should be emphasized that even a moderate amount of overproduction can be very expensive. However, as a result of the inherent difficulties in managing these competing objectives using such forecast-based methods of prior art (once again, the difficulty is due in large part to the lengthy process of vaccine production, the highly variable and often fickle nature of consumer demand, and the variable and somewhat unpredictable nature of various pathogens), the forecast-based methods of prior art expose both the consumers of vaccine and the producers of vaccine to considerable risk. Further, as will be shown below, such long-established, industry-standard, forecast-based methods for matching seasonal supply of vaccine with seasonal demand have been (and continue to remain) dangerously inaccurate.

More specifically, it is important to note that these two competing objectives of (1) providing good health care (e.g., ensuring full access to vaccine) and (2) avoiding excessive or unnecessary financial expense (e.g., avoiding gross overproduction) are generally applicable world-wide; however, these competing objectives are of critical importance in regions of the world having market-driven, free-enterprise-based, healthcare systems, such as that currently found within the United States of America (US). In greater detail, note, for example, that annual vaccine production quantities in such market-driven economies (e.g., the US) are, once again, currently generally based on historical annual or seasonal consumer demand for vaccine, although production quantities are typically adjusted for the relative perceived threat or risk (as perceived by healthcare industry professionals and/or personnel representing governmental health agencies) during the upcoming “season” from new, highly infectious, and/or highly lethal strains of the pathogen (e.g., influenza or “flu” virus). Although the producers of vaccine working in concert with medical practitioners, governmental health agencies, and/or other organizations, are generally able to forecast with somewhat reasonable accuracy the consumer demand for a given year or season, major shortages (as well as excessive overproductions) of vaccine, nonetheless, can occur—and historically do occur—resulting in severe consequences.

As one example of the failings of forecast-based methods of prior art, first note that as a result of the unexpectedly low demand for influenza vaccine in the Unites States during the 2002-2003 “flu” season, many doses of vaccine went unused, thereby representing a significant financial loss to the producers of the vaccine and/or others within the healthcare industry.

As a second example of the failings of prior art, note that in response to the unexpectedly low demand for flu vaccine during the 2002-2003 flu season, the producers of vaccine reduced production quantities for the 2003-2004 flu season based, in part, on the prior flu season's low demand. Unfortunately, the 2003-2004 flu season commenced early and with unusual severity, thereby causing (1) all readily available doses of vaccine to be consumed very early within the flu season and (2) a general shortage of vaccine in most regions of the country. It is strongly emphasized that this shortage in vaccine supply resulted in unnecessary illness, loss of life, loss of time at work and/or school, long waiting lines for vaccine administration, rationing of vaccine by government and health care providers, general panic or hysteria within certain susceptible sectors of the population, and numerous other adverse consequences to society—all because the forecast-based methods of prior art for matching seasonal vaccine supply and seasonal vaccine demand were highly inaccurate for the given season.

As a third example of the failings of prior art, note that in response to the shortage of flu vaccine experienced during the 2003-2004 flu season, the producers of vaccine substantially increased production quantities for the 2004-2005 flu season based, in part, on the supply shortage experienced during the prior flu season. Unfortunately, manufacturing difficulties (in particular, the contamination of vaccine during production at one major producer) caused the irrecoverable loss of approximately half (or approximately 50 million doses) of the nation's flu vaccine supply for the 2004-2005 flu season. Consequently, for the second consecutive flu season, severe shortages of flu vaccine existed throughout most regions of the country. As might be expected, this shortage in vaccine supply resulted, once again, in unnecessary illness, loss of life, loss of time at work and/or school, long waiting lines for vaccine administration, rationing of vaccine by government and health care providers, general panic or hysteria within certain susceptible sectors of the population, and numerous other adverse consequences to society—all because the forecast-based methods of prior art for matching seasonal vaccine supply and seasonal vaccine demand were, once again, highly inaccurate for the given season.

Considering these examples, it is clearly evident that the current forecast-based methods of prior art for establishing vaccine production quantities present very significant risks, both on the supply-side to producers, and on the demand-side to consumers.

Regarding the demand-side risks to healthcare consumers, note that these risks are greatest to young children, the elderly, and/or those with weakened immune systems, all of whom should generally receive flu vaccine seasonally. However, under the methods of prior art, note that these persons currently have no means for ensuring that vaccine will be available to them, thereby placing their health at risk. Worse, for some of these healthcare consumers who might be classified as “high-risk”, reliable access to seasonal vaccine is often nothing less that a matter of life or death.

Regarding the supply-side risk to the producers of vaccine, first note that such for-profit healthcare enterprises will expectedly make every effort to minimize unnecessary financial risk. Further, such producers simply cannot afford to produce vaccine for all those who might want it: to do so would require the producers to produce several times (e.g., three to five times) the typical seasonal demand for vaccine, the vast majority of which would go unused. Ultimately, such excess margin or overproduction would, at least, be wasteful, if not financially damaging or devastating to the producers of vaccine and/or to the government health agencies (or other entities) securing the producer's investment.

b. Disadvantages of Prior Art

In summary, the forecast-based methods of prior art for matching seasonal vaccine supply and seasonal vaccine demand represent numerous disadvantages, both to the vaccine consumer and to the vaccine provider. These many disadvantages of prior art include, but are not limited to:

1. Prior art fails to provide any effective means for substantially ensuring an individual consumer access to one or more seasonal vaccines (or to a particular medically-required type or form of vaccine), thereby seasonally exposing the intended vaccine consumer to unnecessary risk of infection, illness, loss of work or income, other adverse consequences, and possibly death.

2. Prior art fails to provide any reliable means for accurately matching seasonal vaccine supply and demand (i.e., establishing accurate production and/or distribution quantities), often leading to significant overall and/or local imbalances between vaccine supply and demand. In addition to possibly subjecting the involved parties to severe health and/or economic consequences, prior art also frequently forces personnel within the health care industry and/or government health agencies to implement contingency plans to manage a significant vaccine shortage and/or the consequences thereof.

3. Prior art fails to provide any effective means for capturing or securing production costs (or a proxy thereof) from the consumer (and/or the consumer's representative or agent) prior to vaccine delivery and administration, thereby subjecting such producers and/or their financial underwriters (including governmental health agencies) to unnecessary financial risk.

4. Prior art fails to provide any effective means for accurately capturing or obtaining from consumers and providing to the vaccine producers geographical information regarding the intended vaccine consumers, thereby making accurate and timely geographical distribution of vaccine unnecessarily difficult. Thus, the methods of prior art result in the possibility (and real occurrences) of local shortages and/or local oversupply, regardless of the overall balance between supply and demand.

5. Prior art fails to provide any effective means for prompting and/or incentivizing consumers to actually get vaccinated. Additionally, other than by general medical appointments or office visits, prior art provides no readily accessible means for scheduling a simple vaccination, many of which are given outside the medical office (for example, in a community school gymnasium, a local grocery store or pharmacy, and the like), and therefore generally cannot effectively utilize the existing medical infrastructure for appointments.

6. Prior art fails to provide any effective means for post-vaccination evaluation of one or vaccines or other pharmacological agents.

7. Prior art fails to provide any effective means for allowing individuals or other benefactors to charitably gift one or more vaccines to those in need of vaccine, but having insufficient financial means.

8. Prior art fails to provide any effective means for educating the vaccine consumer regarding (1) general and/or specific pathogenic risks or (2) vaccines which might be available to mitigate or eliminate such risks. In addition, prior art fails to provide to the vaccine consumer any effective means for planning or managing personal vaccinations over time.

As one reads subsequent sections of this document, it will become quite clear that prior art has numerous other disadvantages.

Accordingly, there remains a continuing general need within the global healthcare industry for an accurate method of matching annual or seasonal supply of vaccine (i.e., production and/or distribution quantities) with seasonal consumer demand. This unfulfilled need clearly underscores the value of the present invention, which fully and uniquely meets this need.

### SUMMARY OF THE INVENTION

The present invention, in its preferred embodiments, is an automated, consumer-driven, pre-production, seasonal vaccine reservation system for facilitating the efficient production, distribution, and administration of health-critical, long-production-lead-time seasonal vaccines (or other pharmacological agents), whereby use of such a consumer-driven vaccine reservation system provides an effective means and/or method for substantially ensuring or guaranteeing that consumer demand for seasonal vaccine can be fully and consistently met, but without subjecting the producers of vaccine and/or other cognizant parties associated with the healthcare industry to undue financial risk. In addition to the physical elements comprising such a consumer-driven vaccine reservation system, the present invention also represents various unique business methods including, among others, heretofore unrealized methods for accurately (e.g., precisely) matching seasonal vaccine supply with seasonal consumer demand, thereby significantly facilitating the timely and economical production, distribution, and/or administration of seasonal vaccine.

1. Typical Advantages Over Prior Art

The present invention is typically superior to the related art (i.e., the current business practices within the healthcare industry for producing, distributing, and/or administering seasonal vaccine) in at least eight significant respects:

First, the present invention is superior to the related art in that it ensures access to vaccine for all consumers who choose to reserve a vaccine prior to production. In contrast, current medical business practices do not provide such a reservation system, thereby exposing the health care consumer to unnecessary risk of infection and possibly death by providing no guaranteed access to vaccine. Further, there is no clear suggestion within open literature (or otherwise within the healthcare industry) that the healthcare industry has contemplated the improved systems and/or methods as proposed herein, or the benefits thereof.

Second, the present invention is superior to the related art in that it provides an extremely accurate method for matching seasonal supply to seasonal demand, thereby significantly mitigating both the risk of underproduction (i.e., shortages) of vaccine, as well as the risk of expensive overproduction. In contrast, as noted above, prior fails to provide any such provision for accurately matching seasonal vaccine supply and demand, often leading to significant imbalances between vaccine supply and demand, thereby causing severe health and/or economic consequences.

Third, the present invention is superior to the related art in that it ensures the producers of vaccine will be appropriately compensated for substantially all vaccines reserved by the consumer on a pre-production basis, thereby significantly mitigating the financial risks to the producers of vaccine. In contrast, the related art provides no means for capturing or securing production costs (or a proxy thereof) from the consumer (and/or the consumer's representative or agent) prior to vaccine delivery and administration, thereby subjecting such producers and/or their financial underwriters (including governmental health agencies) to significant financial risk.

Fourth, the present invention is superior to the related art in that it optionally provides the producer of vaccine with geographical information regarding the consumers who have reserved a vaccine, thereby facilitating accurate and timely geographical distribution of vaccine. Again, related art contains no such provisions, thus, requiring healthcare industry professionals to forecast need by geographic region, thereby resulting in the possibility (and real occurrences) of local shortages and/or local oversupply, regardless of the overall balance between supply and demand.

Fifth, the present invention is superior to the related art in that it prompts and/or incentivizes consumers to actually get vaccinated by (1) by providing readily accessible optional means for establishing a specific appointment (e.g., date, time, and/or location) for vaccination, (2) providing an optional means for automatically informing consumers of the general availability of vaccine for administration and/or of a specific appointment, thereby reducing lack of vaccination due to procrastination, forgetfulness, distraction, and the like, and/or (3) providing an optional means for incentivizing vaccine consumers, such as by providing a discounted or reduced fee for vaccination if the vaccine is reserved and/or paid prior to the start of production. Other than by general medical appointments or office visits, prior art provides no readily accessible means for scheduling or incentivizing a simple vaccination, many of which are given outside the medical office (for example, in a community school gymnasium, a local grocery store or pharmacy, and the like), and therefore generally cannot effectively utilize the existing medical infrastructure for appointments.

Sixth, the present invention is superior to the related art in that it provides an effective means for post-vaccination evaluation of one or more vaccines or other pharmacological agents.

Seventh, the present invention is superior to the related art in that it provides an effective means for allowing individuals or other benefactors to charitably gift one or more vaccines to those in need of vaccine, but having insufficient financial means. In addition, the present invention is superior to the related art in that it provides an effective means for registering individuals in need of and/or optionally authorized to receive one or more vaccines via charitable gift.

Eight, the present invention is superior to the related art in that it provides an effective means for educating the vaccine consumer regarding (1) the general and/or specific pathogenic risks or (2) vaccines which might be available to mitigate or eliminate such risks. In addition, the present invention is superior in that it provides the vaccine consumer with an effective means for planning or managing personal vaccinations.

As one reads subsequent sections of this document, it will become quite clear that the present invention is also superior to the related art in a variety of other ways including, among other items, providing improved means and/or methods for reporting and tracking the effectiveness of vaccine in preventing illness, adverse reactions to vaccine, and the like.

2. Specific Objects and Advantages of the Present Invention:

Accordingly, it is a principal object of the present invention to provide a substantially automated means (comprising a physical system and/or one or more novel business methods) for permitting vaccine consumers to reserve one or more seasonal vaccines, generally, but not necessarily, on a pre-production basis (such as may be reserved by using an internet-connected electronic computer system hosting a suitable electronic reservation database), thereby substantially ensuring or guaranteeing individual consumers access to one or more health-sustaining seasonal vaccines. Additionally, another closely related object of the present invention is to provide a substantially automated means for permitting the consumer to select and reserve a particular type (or types) of vaccine including, for example, the method of vaccine administration (e.g., injection, nasal mist, oral, and the like), the particular strain (or strains) of pathogen (or pathogens) the consumer wishes to be protected against via one or more vaccines (optionally including the ability to specify one or more custom-produced vaccines for a particular individual or group), and/or the method of vaccine production (e.g., pathogen incubation within the egg of a chicken or, alternatively, some non-allergenic method of vaccine production).

It is a second object of the present invention to provide a substantially automated, typically consumer-driven means (comprising a physical system and/or one or more novel business methods) for matching seasonal vaccine supply with seasonal consumer demand, whereby vaccine production quantities are, at least in part, substantially automatically precisely determined by summing the number of vaccines reserved by the consumer and/or the consumer's representative (such as may be contained within a suitable electronic reservation database hosted on an optionally internet-connected, electronic computer system), thereby simultaneously reducing both the health risk to the consumer associated with underproduction (i.e. shortages) of vaccine, and the financial risk to the producer associated with wasteful overproduction of vaccine.

It is a third object of the present invention to provide a substantially automated, typically consumer-driven means (comprising a physical system and/or one or more novel business methods) for further reducing the financial risk to producers of vaccine and/or other financially interested parties, such as by providing a substantially automated means for collecting payment (either in full or in part) for such reserved vaccines prior to the commencement of vaccine production including, for example, the use of an internet-based or “on-line” electronic store, (or any other well-known means for accepting payment from remote purchasers), and/or a substantially automated electronic computer-based billing system for billing the consumer or some third party (i.e., an insurance company, a government health program, e.g. Medicare/Medicaid, and the like).

It is a fourth object of the present invention to provide a substantially automated, consumer-driven means (comprising a physical system and/or one or more novel business methods) for facilitating timely distribution and/or administration of seasonal vaccine, such as by querying a suitable electronic vaccine reservation database containing the consumer's addresses and/or other relevant geographic or demographic data, thereby enabling the producers to accurately distribute vaccine (accounting for both type and quantity of vaccine) to the appropriate geographic regions, but also enabling regional healthcare providers to determine the required size of the local vaccine administration workforce and/or facilities based on such electronic queries of the vaccine reservation database.

It is a fifth object of the present invention to provide a substantially automated, consumer-driven means (comprising a physical system and/or one or more novel business methods) for directing the consumer regarding the general availability of vaccine for administration within consumer's locality and/or for providing a reminder to the consumer (and/or the consumer's representative) regarding a specific appointment (e.g., date, time, location) for vaccine administration, thereby significantly enhancing the probability that the consumer will actually present himself or herself for vaccination.

It is a sixth object of the present invention to provide a substantially automated, consumer-driven means (comprising a physical system and/or one or more novel business methods) for evaluating the consumer's response to the vaccine, both in terms of the efficacy of the vaccine in preventing illness, and the consumer's adverse reaction to the vaccine, if any, thereby providing an effective means for improved information feedback from the consumer to the healthcare industry.

It is a seventh object of the present invention to provide a substantially automated, consumer-driven means (comprising a physical system and/or one or more novel business methods) for allowing individuals or other benefactors to charitably gift one or more vaccines to those in need of vaccine, but having insufficient financial means. A closely related object of the present invention is to provide an effective means (comprising a physical system and/or one or more novel business methods) for registering individuals in need of and/or optionally authorized to receive one or more vaccines via charitable gift.

It is an eight object of the present invention to provide a substantially automated, consumer-driven means (comprising a physical system and/or one or more novel business methods) for educating the vaccine consumer regarding (1) the general and/or specific pathogenic risks or (2) the vaccines which might be available to mitigate or eliminate such risks. A closely related object of the present invention is to provide the vaccine consumer (or other entity) with an effective means (comprising a physical system and/or one or more novel business methods) for planning and/or managing personal vaccinations over time.

These and other objects of the present invention will become readily apparent upon further review of the following specification and drawing. However, it is emphasized that any particular embodiment or manifestation of the present invention need not perform all such functions or otherwise meet all such objects of the present invention. In addition, it is emphasized that the invention is not intended to be limited to the specific examples as shown or described herein.

Regarding terminology, note that the use of the parenthetical expression “(comprising a physical system and/or one or more novel business methods)” in the preceding paragraphs of this section of the application is specifically intended to define (or equate) the associated “means” language in each of the preceding paragraphs as one or more physical elements of an electronic computing system and/or one or more electronic computing algorithms implemented therein, each of which is operable to perform at least a portion of the function indicated by the associated means language.

### BRIEF DESCRIPTION OF FIGURES

FIG. 1 is a schematic diagram of the primary elements of a typical substantially automated, principally consumer-driven, generally pre-production, seasonal vaccine reservation system.

FIG. 2 is a schematic process flow chart of a typical method of the present invention for permitting consumers to guarantee access to vaccine by reserving one or more seasonal vaccines via use of a substantially automated, principally consumer-driven, generally pre-production, seasonal vaccine reservation system.

FIG. 3 is a schematic process flow chart of a typical method of the present invention for accurately matching seasonal vaccine supply with seasonal consumer demand via use of a substantially automated, principally consumer-driven, generally pre-production, seasonal vaccine reservation system.

FIG. 4 is a schematic process flow chart of a typical method of the present invention for further reducing the financial risk to producers of vaccine via use of a substantially automated, principally consumer-driven, generally pre-production, seasonal vaccine reservation system.

FIG. 5 is a schematic process flow chart of a typical method of the present invention for facilitating distribution and/or timely administration of seasonal vaccine via use of a substantially automated, principally consumer-driven, generally pre-production, seasonal vaccine reservation system.

FIG. 6 is a schematic process flow chart of a typical method of the present invention for directing the consumer regarding the general availability of vaccine for administration (or a specific appointment for vaccine administration) via use of a substantially automated, principally consumer-driven, generally pre-production, seasonal vaccine reservation system.

FIG. 7 is a schematic process flow chart of a typical method of the present invention for evaluating the consumer's response to the vaccine via use of a substantially automated, principally consumer-driven, generally pre-production, seasonal vaccine reservation system.

### DETAILED DESCRIPTION

The present invention, in its preferred embodiments, is a substantially automated, consumer-driven, pre-production, seasonal vaccine reservation system for facilitating the efficient (e.g., accurate, economical, and timely) production, distribution, administration, and/or post-administration evaluation of health-critical, long-production-lead-time seasonal vaccines such as, for example, seasonal influenza or “flu” virus vaccines. The implementation of such a consumer-driven vaccine reservation system provides a highly effective means for substantially ensuring or guaranteeing that consumer demand for seasonal vaccine can be fully and consistently met, but without subjecting the producers of vaccine and/or other cognizant parties associated with the healthcare industry to undue financial risk.

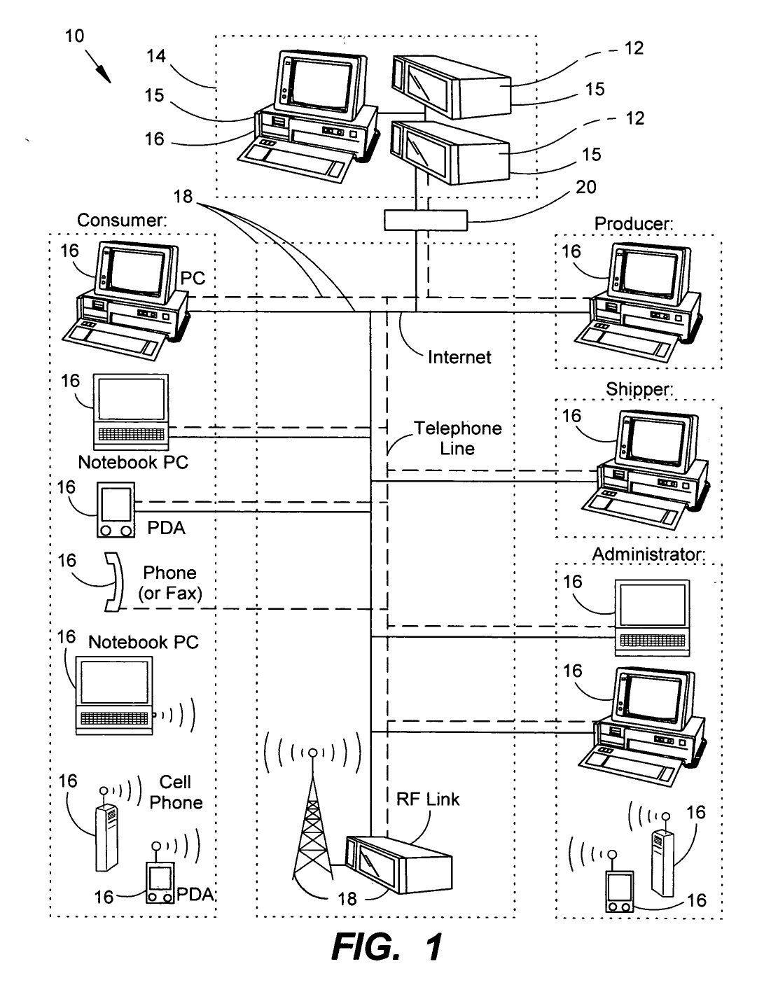

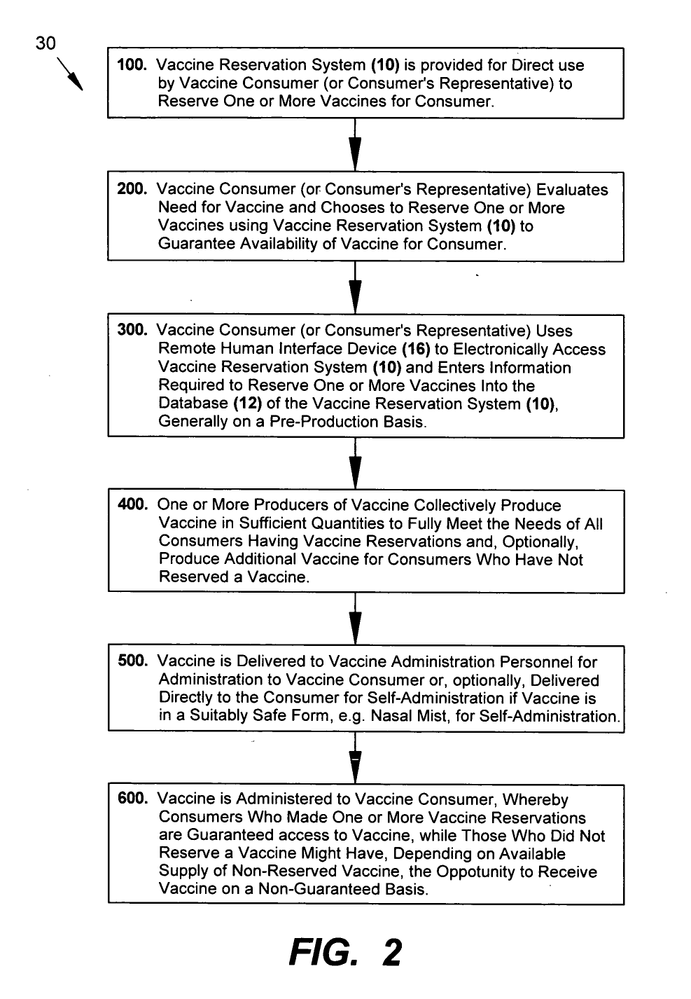

Briefly, FIG. 1 depicts the principal physical elements comprising such a consumer-driven vaccine reservation system, but also shows various optional and/or redundant elements. FIGS. 2-7 depict various unique business methods for facilitating the accurate, economical, and/or timely production, distribution, and/or administration of seasonal vaccine (or other health-critical, long-production-lead-time medical products) using a substantially automated, typically consumer-driven, generally pre-production, seasonal vaccine reservation system.

Regarding terminology, note that “substantially automated” indicates that the vaccine reservation system significantly utilizes electronic computing devices, operable logical computer algorithms, and/or other automation tools to provide and/or perform a substantial portion of the system and/or the methods or functions thereby performed. Additionally, “consumer-driven”, as used herein, indicates that the consumer (or a representative thereof) has primary responsibility for making a vaccine reservation using the vaccine reservation system of the present invention, whereby such reservations made by the consumer will ultimately be used to significantly or substantially establish or “drive” production quantities. Further, “pre-production” indicates that reservations are substantially made prior to the commencement of production of vaccine, whereby such pre-production reservations have the ability to affect or influence the quantities of vaccine which will be produced.

It is noted that FIGS. 1-7, in concert with the description of the invention as presented herein, provide several specific embodiments (or parts thereof) of the present invention; however, it is emphasized that the invention is not limited to the specific examples of the physical systems and/or the improved business methods as depicted or described herein. More specifically, the present invention contemplates and anticipates numerous alternate configurations of these systems and/or methods, including various combinations, simplifications, and/or other modifications thereof, without departing from the nature of the invention. Additionally, although the invention disclosed herein is principally described as various means and/or improved methods for facilitating the production, distribution, and/or administration of seasonal vaccine, it is noted the present invention is also highly applicable to other pharmacological agents, such as, for example, anti-biological warfare agents and/or other newly developed or limited-availability agents.

FIG. 1 Description and Operation of Vaccine Reservation System:

As depicted in FIG. 1, the basic vaccine reservation system 10 principally comprises one or more electronic computer databases 12 for receiving, storing, processing, and/or outputting seasonal vaccine reservations in electronic format, one or more optionally networked electronic computer systems 14 suitable for hosting and/or operating such electronic database(s) 12, and one or more typically remote, preferably substantially electronically automated, human-interface means 16 for inputting and/or retrieving vaccine reservation information from the electronic database 12. Such remote human interface means 16 are generally electronically connected to the computer system 14 and, hence, the database 12 via existing electronic communications infrastructure 18, such as the Internet, wired or wireless electronic networks, and/or telephone lines, using various commercially available connection means 20 including, for example, routers, servers, modems, and/or the like (not specifically shown).

In greater detail, the electronic database 12 is preferably a custom-configured implementation of a generally commercially available, electronic database software algorithm capable of receiving, storing, processing, and/or outputting a plurality of vaccine reservation records, wherein each record contains one or more data fields related to a particular vaccine reservation for a particular individual or group (such as a family). It is anticipated that the database 12 can also output various results derived from sorting, parsing, summing, and/or otherwise processing the reservation records contained therein for one or more useful purposes as described herein, or as known to the user of the database 12. It is noted that any suitable custom configurable, commercially available, electronic database may be implemented to provide database 12; however, fully customized software algorithms optionally may be utilized to provide all or part of the database system 12. It is further noted that any commercially available and/or custom-authored helper applications/sub-applications (e.g., applets, macros, etc.) may be used as part of, or in concert with, the database 12 for processing the data records contained therein, and/or for inputting and/or outputting information from the database 12. The specific apparatus, methods, and/or tools for implementing such a database 12, as well as manipulating the records contained therein, are well known to those skilled in the art, and do not require further description herein.

The electronic computer system 14 comprises one or more suitable, commercially available, electronic computers 15 (i.e., computing devices) including, for example, a microcomputer, minicomputer, mainframe, workstation, server, portable computer, personal digital assistant (PDA), and/or other electronic computing devices having a means for receiving, storing, processing, and/or outputting information related to one or more vaccine reservations (i.e., capable of hosting all or part of the database 12 and/or capable of manipulating, transacting, communicating, and/or otherwise processing one or more of the data records contained in the database 12 or derived from the database 12). In the event that a plurality of electronic computing devices 15 are utilized to provide the electronic computer system 14, one or more of such computing devices 15 are generally (but not necessary) networked as shown to form an integrated high-performance system and/or to provide redundant capabilities in the event of failure of one or more computing devices 15. It is noted that any of the standard peripheral and/or accessory elements of such computing devices, such as those commonly known to those skilled in the art, are optionally incorporated into the computing system 14 and/or the computing device 15. Examples include keyboards, pointing devices displays, various media reading/writing devices, and the like.

The human-interface means 16 for inputting and/or retrieving vaccine reservation information from the electronic database 12 is preferably an internet-connected electronic computing device, substantially identical or similar to one or more of the electronic computing devices 15 used to host the database 12 as noted above. More specifically, for inputting a vaccine reservation into the database (i.e., “making a vaccine reservation”) such as by the consumer or a consumer's representative (thereby being a “consumer-driven” system or method), the preferred human-interface means 16 is a consumer-owner, Internet-connected (or otherwise electronically connected) desktop microcomputer, portable computer, PDA, and the like. It should be emphasized that by employing such consumer-owned and/or operated computing devices to access the database 12, the capital cost of implementing the present invention on a national or global scale is extremely low.

To facilitate making the reservation, it is anticipated that a suitable graphical user interface (GUI), such as a fill-in type electronic form, is presented (i.e., displayed) to the consumer/user by a human-interface computing device 16, which typically has at least one display screen. The methods for presenting and/or collecting information using an interactive graphical user interface are commonly known to those skilled in the art and, thus, need not be further described herein. Nonetheless, it should be noted that a typical electronic form, which may be presented to the user via computing device 16 to facilitate the reservation of one or more vaccines, would typically include labeled fill-in data fields for such items as name, identification number(s), address, phone number, age, gender, preferred vaccine type or types, insurance company data, payment information, and/or the like, plus one or more process-initiating “radio” buttons (typically on-screen) such as may be used (e.g., electronically activated or “clicked”) to submit, edit, and/or cancel a reservation, or to initiate one or more other functions related to the present invention.

The invention contemplates that the vaccine reservation system 10 optionally may incorporate, either alternatively or additionally, other means for entering one or more vaccine reservations into the database 12 including, for example, (1) a menu-driven telephonic input system, (2) a human-assisted voice-based telephonic input system (not shown), (3) a voice-based telephonic input system which processes reservations by voice-recognition means (not shown), (4) a human-assisted fax-based reservation input form (not shown), (5) a fax-based reservation input form processed by optical character recognition (not shown), (6) an electronic-mail or paper-mail input means (not shown) optionally human-assisted and/or assisted by optical character recognition means, (7) a paper-based means employing a human registrar (not shown) who will later enter the reservation into the database 12, (8) a network-connected electronic medical records/patient care system capable of automatically selecting and reserving one or more vaccines, and/or the like.

Regarding the existing electronic communications infrastructure 18, it is noted that the Internet is the generally preferred means for interconnecting the computer system 14 hosting the database 12 to the remote human interface means 16. However, the invention contemplates that numerous other interconnecting means may be employed for this purpose including, for example, a standard telephone line, a direct subscriber line (DSL), satellite links (not shown), other electromagnetic links such as radio frequency (RF) links (e.g., wireless network, “wi-fi”, cellular phone), infrared links, and/or the like. It should be noted that such wireless communications technologies can greatly facilitate field operations associated with making reservations as well as producing, distributing, and/or administering vaccine.

As noted above, various commercially available connection means 20 may be utilized to facilitate or enable the interconnection of the computer system 14, its individual computing elements 15, and/or the various human interface means 16 including, for example, routers, servers, modems, and/or the like. However, the invention contemplates the one or more persons may also be utilized to transfer information related to one or more reservations between the various elements of the system, or between the various elements of the system and the primary users of the system. Although not a preferred method of operating the vaccine reservation system 10, the optional addition of human assistants (not shown) to the vaccine reservation system 10 dramatically increases the versatility of the system 10, especially in respect to making reservation for those vaccine consumers (or other users of the system including representatives of the consumer, the producers, the shippers or distributors, the vaccine administrators, and the like) who have either a limited ability or no ability to utilize the various technology-based human interface means 16.

Additionally, the invention contemplates that the vaccine reservation system 10 can be operated in, and/or provides a means for operating in, multiple languages (e.g., English, Spanish, French, German, and many other languages). Additionally, the invention contemplates that the vaccine reservation system can directly assist with translating between such different languages to facilitate vaccine reservation as well as vaccine production, distribution, and administration, the latter of which may be especially useful in highly bilingual or multilingual regions of the world.

It should be emphasized that many of the physical elements of the present invention are readily commercially available and, thus, are generally well known to those skilled in the art; however, this general arrangement configured for the unique purposes and processes described herein represents the core of the present invention.

FIGS. 2-7 Improved Business Methods for Producing, Distributing, and/or Administering Seasonal Vaccines:

In addition to the physical elements comprising the consumer-driven vaccine reservation system 10 (including hardware, software, electronic communications infrastructure, and other elements), the present invention also represents various unique improved business methods or means for facilitating the production, distribution, and/or administration of seasonal vaccine (or other health-critical, long-production-lead-time pharmacological agents). Such improved business methods include, for example, (1) a substantially automated method or means 30 for guaranteeing access of any particular individual (or group) to one or more health/life-sustaining doses of vaccine via individual (or group) reservation made generally, but not necessarily, on a pre-production basis using vaccine reservation system 10, (2) a substantially automated method or means 40 for accurately (e.g., precisely) matching seasonal vaccine supply (i.e., production quantities) with seasonal consumer demand by querying the database 12 for the total number and/or type of vaccine reservations, thereby mitigating both health risks due to shortage as well as financial risks due to overproduction, (3) a substantially automated method or means 50 for mitigating the financial risk of vaccine production to the producers of vaccine by providing a means for securing from the vaccine consumer (or the consumer's representative) a pre-production payment and/or other financial commitment (such as a refundable deposit which is refunded upon vaccine administration and subsequently billed to a third party), (4) a substantially automated method or means 60 for facilitating accurate (e.g., precise) regional and/or local distribution of vaccine by querying consumer geographic information contained database 12, (5) a substantially automated method or means 70 for advising consumers of vaccine availability and/or for reminding consumers of a specific appointment for vaccine administration via automated generation and transmission of appropriate communications to such consumers, and/or (6) a substantially automated method or means 80 for evaluating the efficacy of, and/or any adverse reactivity to, seasonal vaccine by providing various electronic consumer feedback mechanisms, such as, for example, an interactive, fill-in type, electronic form or survey presented to the consumer via internet-connected computer or any other suitable human interface mechanism 16. In addition, several of the above methods or means can be modified to perform or achieve one or other useful functions, as will be shown below.

FIG. 2 Description and Operation as a Means for Guaranteeing Access to Vaccine:

FIG. 2 depicts an improved business method of the present invention in a preferred first embodiment 30 comprising a substantially automated method or means for guaranteeing access of any particular individual (or group) to one or more health/life-sustaining doses of vaccine via individual (or group) reservation made generally, but not necessarily, on a pre-production basis using vaccine reservation system 10.

Briefly, vaccine reservation system 10 and business method 30 function in concert to guarantee access to vaccine generally by having the consumer of the vaccine (or any authorized individual or organization acting on behalf of the consumer) reserve at least one vaccine in the consumer's name (or by other identifying means) generally, but not necessarily, prior to the commencement of production. The process of reserving a vaccine is generally (but not necessarily) substantially accomplished by the consumer's (or a representative's) use of an electronic human-interface input means 16 (such as, for example, a fill-in electronic reservation form presented on an internet-connected computer terminal, a menu-driven telephonic input system, or by other methods noted above) to enter the necessary personal information into database 12 as required to secure one or more vaccine reservations. Confirmation of the vaccine reservation is optionally generally provided to the consumer (or a representative thereof) automatically by the reservation system 10 and/or its operators, typically using one or more of the aforementioned communication processes and/or devices 16.

In greater detail, as shown in FIG. 2, method 30 for guaranteeing access to vaccine using the consumer-driven vaccine reservation system 10 typically comprises the following steps:
(100) providing a suitable vaccine reservation system 10 enabling direct use by the vaccine consumer (or the consumer's representative) as a means to reserve one or more vaccines (or other pharmacological agents);
(200) having the vaccine consumer (or the consumer's representative) evaluate the need for vaccination and then choose to reserve one or more suitable vaccines to guarantee availability of such vaccines to the consumer;
(300) having the vaccine consumer (or the consumer's representative) electronically access vaccine reservation system 10 typically via remote human-interface device 16 to enter into database 12 the data required to reserve one or more vaccines, generally (but not necessarily) on a pre-production basis;
(400) having one or more producers of vaccine collectively produce vaccine in sufficient quantities to fully meet the needs of all consumers having vaccine reservations;
(500) distributing vaccine to vaccine administration personnel or, optionally, to the consumer (or the consumer's representative) for self-administration if the vaccine is in a suitably safe form (e.g., nasal mist, oral) to permit self-administration; and
(600) administering the health/life-sustaining vaccine, as substantially guaranteed by using the vaccine reservation system 10.

It should be noted that one or more of the preceding steps of method 30 may contain a plurality of sub-steps; however, the summary of steps presented above, especially when considered in combination with other descriptions and/or depictions of the present invention as disclosed herein, is more than adequate to fully convey to persons skilled in the art the fundamental nature of method 30, as well as how to implement and operate method 30 using the vaccine reservation system 10.

Nonetheless, note that providing a suitable vaccine reservation system per step 100 above generally entails providing a suitable electronic reservation database 12, providing at least one preferably internet-connected electronic computer system 14 for hosting database 12, and further providing at least one suitable remote human interface means or device 16 (i.e., an input/output means, such another internet-connected electronic computer system, a menu-driven telephonic system, a network-connected electronic medical records/patient care system capable of automatically selecting and reserving one or more vaccines, and/or the like) for use by the consumer or the consumer's representative when making a reservation. Note that the consumer's “representative” can include, for example, the consumer's guardian, the consumer's health care professional (e.g., doctor, nurse, insurance company), the consumer's employer or school, and/or the like.

Additionally, note that operating the apparatus 10 to reserve a vaccine using method 30 generally requires the performance of at least steps 200 and 300. Accordingly, steps 400, 500, and 600 may optionally be performed to achieve their respective functions and/or benefits, as described.

The basic method 30 for guaranteeing access to vaccine by using vaccine reservation system 10 can be altered, modified, and/or supplemented in numerous ways.

As one example, the present invention contemplates optionally further including a substantially automated method and/or means for permitting the consumer to select and reserve a particular type of vaccine including, for example, (1) the method of vaccine administration (i.e., injection, nasal mist, and the like), (2) the particular strain (or strains) of pathogen (or pathogens) that the consumer wishes to be protected against via one or more vaccines (optionally including the ability to specify a custom-produced vaccine for a particular individual or group), and/or (3) the method of vaccine production (e.g., pathogen incubation within the egg of a chicken or, alternatively, some non-allergenic method of vaccine production). Note that these modifications to method 30 would typically entail modifying steps 200 and 300 to incorporate the noted additional method and/or means.

As another example, to guard against possible unexpected disruptions in the production of vaccine, the present invention contemplates providing a substantially automated method and/or means for reserving a plurality of vaccines for an individual consumer (including at least one redundant or spare vaccine in the event of loss of the primary vaccine), wherein the plurality of vaccines are produced, for example, (1) by the same manufacturer, optionally at the same plant site, (2) by the same manufacturer, but optionally in distinctly different production batches, (3) by different manufactures, (4) at different geographic locations or plant sites, (5) within different political or other authoritative boundaries, and/or the like. Note that these modifications to method 30 would, once again, typically entail modifying step 300 to incorporate the noted additional method and/or means. Similarly, to guard against possible unexpected disruptions in the distribution and/or administration of vaccine, the present invention further contemplates providing substantially automated methods and/or means for separately distributing and/or administering the plurality of vaccines to the consumer. Note that these modifications to method 30 would typically entail modifying step 300 to incorporate the noted additional method and/or means.

As another example of a modified or alternate configuration of the invention, the invention further contemplates providing a method and/or means for reserving and storing, optionally at a predetermined location, one or more existing and/or future-produced vaccines for the exclusive future use of the particular consumer. Such a means and/or method is particularly useful for guaranteeing access to little-used agents, such as anti-biological warfare agents, which are generally not available in sufficient quantities for all persons in the unlikely event of a crisis. Further, such methods and/or means are useful for ensuring that currently available vaccine will be available at some future date when it is more medically appropriate for the consumer to receive the vaccine. For example, a pregnant mother may wish to reserve a flu vaccine for future administration, when it is less likely to interfere with her pregnancy. Note that these modifications to method 30 would typically entail modifying step 300 to incorporate the noted additional method and/or means.

As yet another example of a modified configuration, the invention further contemplates providing a substantially automated method and/or means for selecting, planning, and/or managing personal vaccinations, including past, present, and/or future vaccinations. The invention further contemplates providing a substantially automated method and/or means for educating the vaccine consumer (or other interested parties) regarding (1) the general risks that pathogens generally pose to potential vaccine consumers, (2) the typical vaccines which may be available to mitigate such risk, (3) specific real-time forecasts of pathogen threats for a particular geographic region, and/or (4) specific vaccines suitable for a particular consumer, optionally based upon personal data (e.g., age, gender, existing medical conditions, and the like) entered into the system 10. Note that such an educational tool can be incorporated either as a part of the aforementioned vaccine selection, planning, and management tool, or as a separate module. Nonetheless, note that these modifications to method 30 would typically entail modifying step 200 to incorporate the noted additional method and/or means.

As still another example of a modified configuration, the present invention further contemplates providing a substantially automated method and/or means for allowing individuals or other benefactors to charitably gift one or more vaccines to those in need of vaccine, but who are of limited financial means. To facilitate such charitable gifting of vaccines (or other medical services), the invention also contemplates providing a substantially automated method and/or means for registering individuals in need of, and optionally authorized to receive by some authorizing agency (e.g., a social welfare office and the like), one or more vaccines via charitable gift. In addition, the invention contemplates that such charitable gifts can be made directly to a particular needy individual or group, or to some unspecified individual or group, and that the donated vaccine may optionally be vaccine which is reserved and purchased specifically as a charitable gift, or vaccine which represents an individuals “spare” or “redundant” vaccine in the event that the spare vaccine is not needed by the individual. Regardless, it should be noted that such opportunities for charitable gifting also provide an excellent financial incentive to the donor to donate vaccine as a result of the potential tax-deductible status of the charitable vaccine donation. It should also be noted that the present invention further contemplates providing other methods and/or means for providing financial incentives related to vaccination, such as by providing discounts for (1) groups (e.g., families, schools, employers, and the like), (2) fully or partially pre-paying for reserved vaccines prior to the commencement of production, (3) electing to subscribe to yearly vaccinations for the number of years (by using a suitable means and/or method optionally incorporated into system 10. Note that these modifications to method 30 would typically entail modifying step 300 to incorporate the noted additional method and/or means.

It is emphasized that method 30 is generally the most critically important aspect of the present invention from a humanitarian perspective, considering that reliable (e.g., guaranteed) access to vaccine is necessary for saving the lives of thousands of persons annually, and preserving the general health of millions more. However, the data contained within database 12 (as a result or implementing method 30, steps 100-300) also has significant economic value in that such data can be readily utilized to more accurately balance seasonal vaccine supply and demand, thereby significantly reducing financial risks associated with vaccine production, distribution, and/or administration, and for other purposes, as will be shown below.

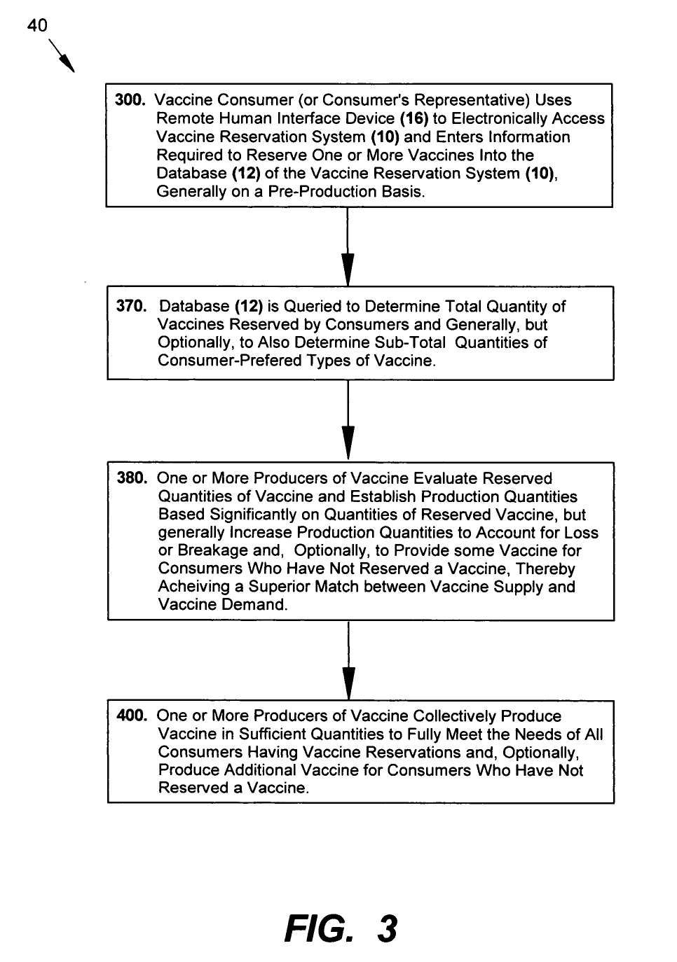

FIG. 3 Description and Operation as a Means for Accurately Matching Vaccine Supply and Demand:

FIG. 3 depicts an alternate embodiment 40 of the present invention comprising a substantially automated method or means for accurately matching seasonal vaccine supply (i.e., production quantities) with seasonal consumer demand.

Briefly, method 40 generally entails querying the database 12 for the total number and/or type of reserved vaccines, which subsequently can be used to accurately determine the necessary production quantities, thereby mitigating both health risks due to shortage of vaccine, as well as financial risks due to overproduction of vaccine. It is noted that method or means 40 is generally a modification of method 30, whereby additional steps are incorporated into method 30 to accurately match seasonal vaccine supply with seasonal consumer demand.

In greater detail, as shown in FIG. 3, method 40 for accurately matching seasonal vaccine supply (i.e., production quantities) with seasonal consumer demand using the consumer-driven vaccine reservation system 10 typically comprises steps 100-600 as depicted above FIG. 2 (of which only steps 300 and 400 are shown in FIG. 3), but further comprises (generally between the previously defined steps 300 and 400) the following additional steps:
(370) querying database 12 to determine the total quantities of each type of reserved vaccine, as previously reserved by the consumer (or the consumers representative) via vaccine reservation step 300; and
(380) establishing production quantities based significantly on such total quantities of reserved vaccine, but generally increasing production quantities to account for loss and/or breakage, and optionally further increasing production quantities to provide some vaccine for consumers who have not reserved a vaccine on a pre-production basis, whereby the production quantities so established provide a far more accurate balance between seasonal vaccine supply and seasonal demand.

By using method 40 to precisely evaluate consumer demand for seasonal vaccine for a significant portion of the vaccine-consuming population, producers of vaccine are able to much more accurately and reliably match vaccine production quantities to the now largely pre-determined consumer demand. In addition to enabling the producers of vaccine to produce the correct total number or doses of vaccine, it is emphasized that method 40 also enables the producer to produce each of several different types of vaccine in the appropriate quantities by automatically parsing and sub-totaling the records in the vaccine reservation database 12. The latter ability is particularly important considering that certain portions of the population cannot take certain types of vaccine; therefore, it is necessary to have a sufficient quantity of each type of vaccine, which may vary significantly in cost and/or effectiveness.

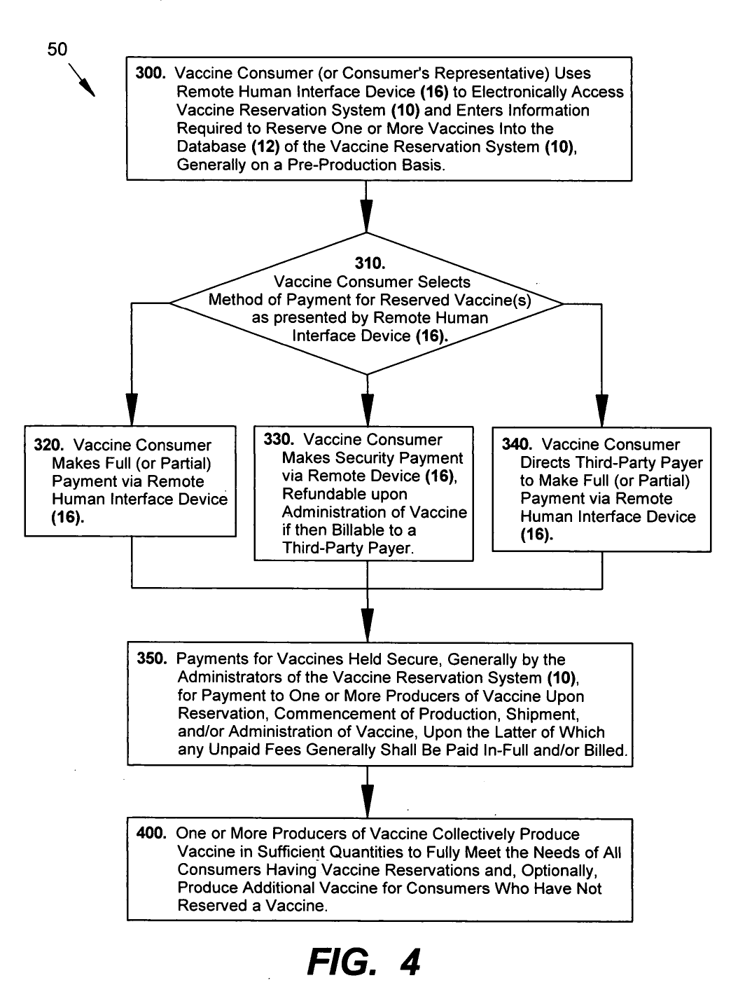

FIG. 4 Description and Operation as a Means for Mitigating Financial Risks of Vaccine Production:

FIG. 4 depicts an alternate embodiment 50 of the present invention comprising a substantially automated method or means 50 for further mitigating the financial risk of vaccine production to the producers of vaccine and/or other financially interested parties, such as a governmental health agency underwriting or securing the producer's investment.

Briefly, method 50 generally entails providing a means for securing from the vaccine consumer (or the consumer's representative) a pre-production payment and/or other financial commitment (such as a refundable deposit which is refunded upon vaccine administration and subsequently billed to a third party). It is noted that method or means 50 is generally a modification of method 30, whereby additional steps are incorporated into method 30 to provide a means for securing payment (or a proxy thereof) from the vaccine consumer or the consumer's representative, generally but not necessarily prior to the commencement of production.

In greater detail, as shown in FIG. 4, method 50 for further mitigating the financial risk of vaccine production using the consumer-driven vaccine reservation system 10 typically comprises steps 100-600 as previously depicted in FIG. 2 (of which only steps 300 and 400 are shown in FIG. 4), but further comprises (generally between the previously defined steps 300 and 400) the following additional steps:
(310) having vaccine consumer (or a representative) select a method of payment for the reserved vaccines as presented by remote human-interface device 16, examples of which include, but are not limited to:
   (320) having vaccine consumer (or consumer's representative) make full or partial payment via remote human-interface device 16; or
   (330) having vaccine consumer (or consumer's representative) make a security-deposit-type payment via remote human-interface device 16, whereby such payment is refundable upon administration of vaccine if the vaccine is then billable to a third-party payer, such as an insurance company, a government health program (e.g. Medicare,/Medicaid), an employer, a school, and the like; or
   (340) having vaccine consumer (or consumer's representative) direct a third-party payer to make full or partial payment via remote human-interface device 16; and
(350) holding payments secure for payment to the producers or providers of vaccine typically either upon reservation, commencement of production, shipment, and/or the administration of vaccine, upon the latter of which any unpaid fees for such vaccines generally shall be paid in full and/or billed to some third party.

The specific equipment and processes for collecting payment can be any common means known to those skilled in the art, but include, for example, receipt of payments via credit or debit card using internet-connected computer terminals (preferably encrypted for security), menu-driven telephonic payment systems, conventional check by mail, automatic billing to a third party (i.e., health insurance company or government healthcare program, e.g., Medicaid/Medicare), and the like.

The basic method 50 for further mitigating the financial risk of vaccine production to the producers of vaccine by collecting payment using vaccine reservation system 10 can be altered and/or supplemented in numerous ways. In particular, method 50 can also be used to provide a financial benefit or incentive to the consumer (or the consumer's representative) by providing reduced or discounted fees for reserving and/or pre-paying one or more vaccines prior to the commencement of production. Similarly, discounts can be provided for families, other groups, self-administered vaccines, and/or the like.

Considering that all fees for vaccines can thus be paid in advance of production, method 50 of the present invention provides a highly effective method for substantially eliminating financial risk to the producers of vaccine.

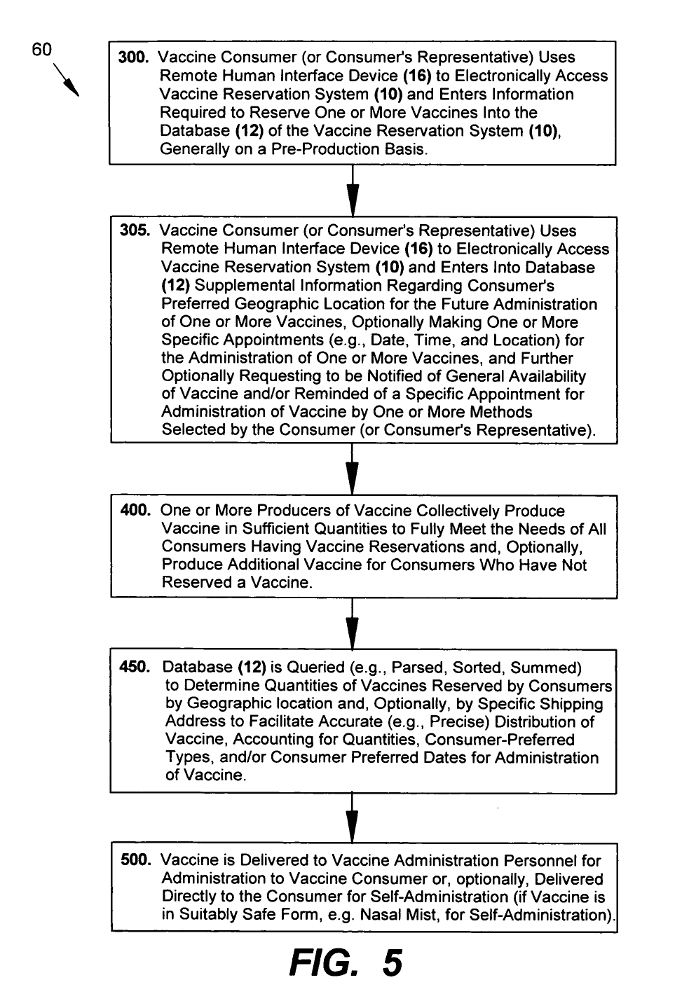

FIG. 5 Description and Operation as a Means for Facilitating Vaccine Distribution:

FIG. 5 depicts an alternate embodiment 60 of the present invention comprising a substantially automated method or means 60 for facilitating accurate (e.g., precise) regional and/or local distribution of vaccine, generally by querying or parsing the consumer's geographic information contained within database 12 to determine the precise quantities of each type of vaccine to distribute (i.e., ship) to each region and/or specific address.

It is noted that method or means 60 is, once again, generally a modification of method 30, whereby additional steps are incorporated into method 30 to provide a means for collecting additional geographic data as required to facilitate accurate distribution, and by further including a querying or parsing step to determine the precise quantities of each type of vaccine to ship to each region and/or specific address.

In greater detail, as shown in FIG. 5, method 60 for facilitating accurate regional and/or local distribution of vaccine using the consumer-driven vaccine reservation system 10 typically comprises steps 100-600 as depicted above FIG. 2 (of which only steps 300, 400, and 500 are shown in FIG. 5), but further comprising a first additional step (generally between the previously defined steps 300 and 400) and a second additional step (generally between the previously defined steps 400 and 500), including the following additional steps:
(305) having vaccine consumer (or consumer's representative) electronically access vaccine reservation system 10 typically via remote human-interface device 16 to enter into database 12 the necessary geographic and/or demographic data required to facilitate distribution of one or more vaccines, optionally further entering data as required to make a specific appointment for vaccine administration, and optionally additionally entering data as required to request an automatic notice regarding the general availability of vaccine for administration and/or a reminder of a specific appointment for vaccination; and
(450) querying database 12 to determine the total quantities of each type of reserved vaccine to distribute to each region and/or specific address, optionally accounting for consumer-preferred dates for administration.

Overall, method 60 provides a highly effective means for precisely distributing reserved vaccines, both geographically and temporally, thereby significantly facilitating both the distribution and timely administration of vaccine.

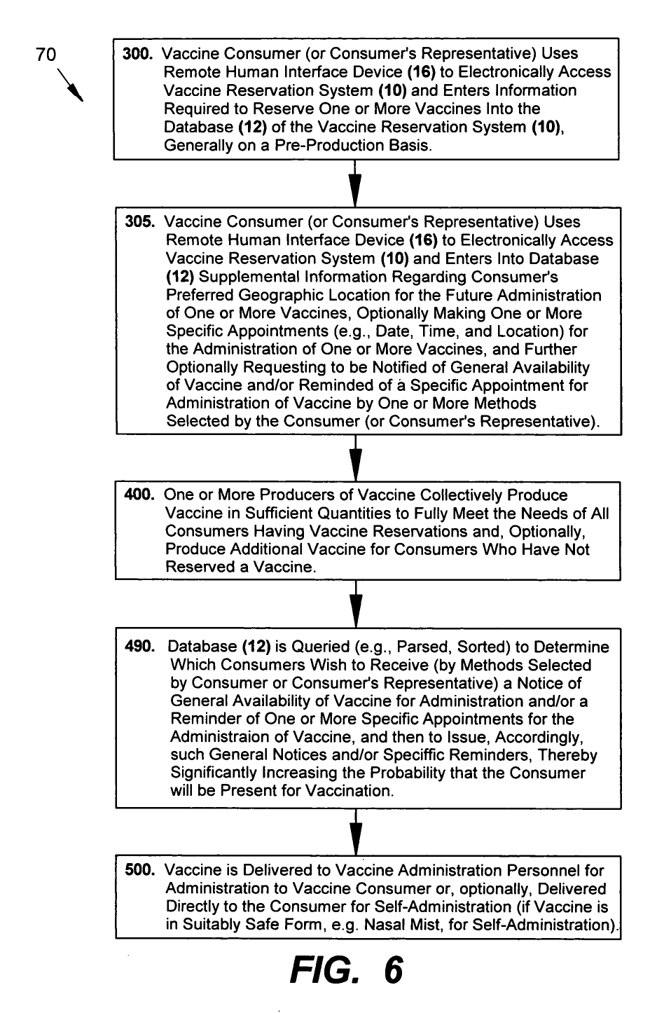

FIG. 6 Description and Operation as a Means for Advising Consumers of Vaccine Availability:

FIG. 6 depicts an alternate embodiment 70 of the present invention comprising a substantially automated method or means 70 for advising consumers of vaccine availability and/or reminding consumers of a specific appointment for vaccine administration via automated generation and transmission of appropriate communications to such consumers.

Briefly, method 70 generally entails querying the database 12 to determine which consumers (or consumers' representatives) wish to receive an automatic announcement regarding the general availability of vaccine for administration, and/or a reminder of a specific appointment for vaccine administration. It is noted that method or means 70 is, once again, generally a modification of method 30, whereby additional steps are incorporated into method 30 to provide a means for collection additional geographic data as required to facilitate accurate distribution, and by further including a querying or parsing step to determine which consumers (or consumers' representatives) wish to receive an automatic announcement and, subsequently the issuing of such announcement(s).

In greater detail, as shown in FIG. 6, method 70 for advising consumers (or consumers' representatives) regarding the availability of vaccine for administration using the consumer-driven vaccine reservation system 10 typically comprises steps 100-600 as depicted above FIG. 2 (of which only steps 300, 400, and 500 are shown in FIG. 6), but further comprising a first additional step (generally between the previously defined steps 300 and 400) and a second additional step (generally between the previously defined steps 400 and 500), including the following additional steps:
(305) having vaccine consumer (or consumer's representative) electronically access vaccine reservation system 10 typically via remote human-interface device 16 to enter into database 12 the necessary geographic and/or demographic data required to facilitate distribution of one or more vaccines, optionally further entering data as required to make a specific appointment for vaccine administration, and optionally additionally entering data as required to request an automatic notice regarding the general availability of vaccine for administration and/or a reminder of a specific appointment for vaccination; and
(490) querying database 12 to determine which consumers (or consumers' representatives) wish to receive an automatic announcement, and the issuing of such announcements by methods selected by the consumer (or consumer's representative.

Overall, method 70 provides a highly effective means for increasing vaccination rates by prompting consumers to actually present themselves for vaccination.

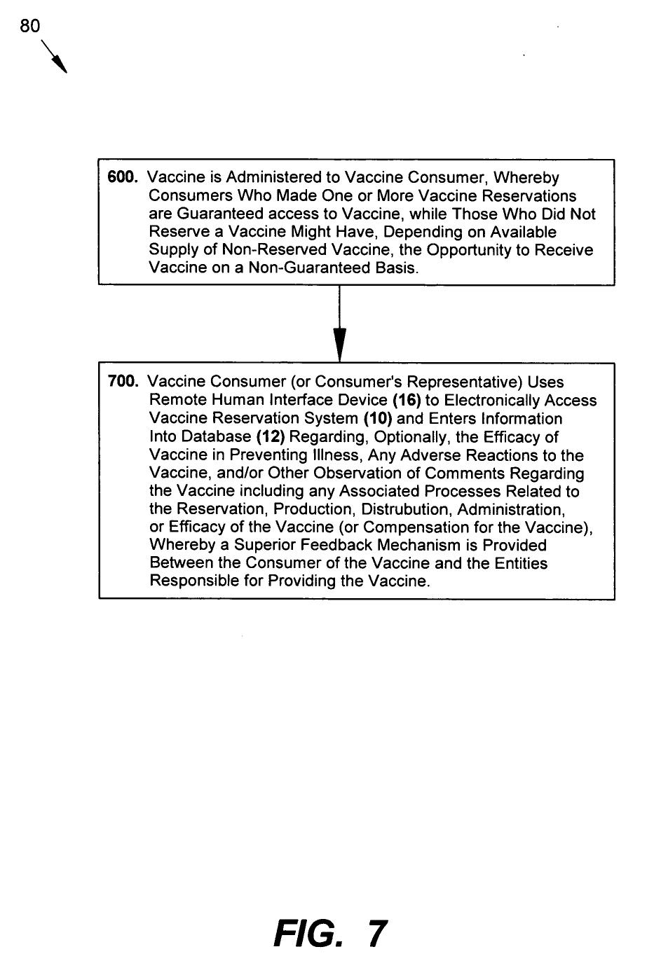

FIG. 7 Description and Operation as a Means for Obtaining Consumer Response to Vaccine:

FIG. 7 depicts an alternate embodiment 80 of the present invention comprising a substantially automated method and/or means 80 for evaluating the efficacy of, and/or any adverse reactivity to, seasonal vaccine, thereby significantly improving feedback regarding the vaccine from the consumer to the producers of vaccine and/or the broader healthcare industry.

Briefly, method 80 generally entails providing various electronic consumer feedback mechanisms, such as, for example, a telephonic survey or an interactive, fill-in type, electronic form or survey presented to the consumer via internet-connected computer or any other suitable human interface mechanism 16. It is noted that method or means 80 is generally a simple extension of method 30, whereby one additional step is appended to method 30 to provide a means for evaluating the efficacy of, and/or any adverse reactivity to, seasonal vaccine.

In greater detail, as shown in FIG. 7, method 80 for providing a means for obtaining consumer response to vaccine using the consumer-driven vaccine reservation system 10 typically comprises steps 100-600 as depicted above FIG. 2 (of which only step 600 is shown in FIG. 7), but further comprising one additional step (generally appended after previously defined step 600), including the following additional step:
(700) having vaccine consumer (or consumer's representative) electronically access vaccine reservation system 10 typically via remote human-interface device 16 to enter into database 12 any observations or comments regarding the efficacy of one or more vaccines in preventing illness, and adverse reaction to such vaccines, and/or any other comments related to the reservation, production, distribution, and/or administration of vaccine.

Overall, method 80 provides a highly effective means for significantly improving feedback regarding the vaccine from the consumer to the producers of vaccine and/or the broader healthcare industry.

Operation as a Means for Reducing Governmental Responsibility:

The present invention provides a unique means for transferring responsibility for individual consumer access to vaccine to the particular vaccine-consuming individual, thus substantially removing from government health agencies and/or other agencies operating in the public's interest the burden of responsibility for ensuring individual access to vaccine.

Information Security Means:

To provide adequate security of the consumer's personal information (including identification data, financial data, medical data, and perhaps other data), the present invention fully contemplates and anticipates the need to use secure techniques for electronic transmission of data. Accordingly, any of the devices, methods, and/or processes described herein are considered to incorporate, where possible, state-of-the-art data-encryption protocols, firewalls, and/or other security features, as well as any legislatively mandated protocols for protecting or securing the privacy of patient medical records.

Information Update Means:

To facilitate many of the above methods or functions of the present invention, note that the present invention further contemplates various well-known substantially automated methods and/or means for updating, correcting, or otherwise revising, any information provided to reserve, make payment for, produce, distribute, store, administer, evaluate, and/or otherwise process vaccine.

Thus, the extensive applicability of the fundamental consumer-driven, pre-production, seasonal vaccine reservation system for facilitating the efficient production, distribution, administration and/or post-administration evaluation of health-critical, long-production-lead-time seasonal vaccines has been disclosed.

1. A substantially automated, consumer-driven, vaccine reservation system comprising:
at least one electronic database suitably configured to receive, store, and process vaccine reservations;
at least one electronic computer system suitably configured for hosting said electronic database; and
at least one human interface means for enabling vaccine reservation information to be optionally input to or output from said electronic database system;
whereby said vaccine reservation system enables a vaccine consumer or optionally a representative thereof to reserve at least one vaccine optionally on a pre-production basis to substantially guarantee said vaccine consumer access to said vaccine.

2. The vaccine reservation system according to claim 1 further including:
a preferably substantially automated means for summing the number of reserved vaccines contained with said electronic database, whereby the sum of reserved vaccines is available to at least one vaccine producer as an aid for determining vaccine production quantity.

3. The vaccine reservation system according to claim 1 further including:
a preferably substantially automated means for accepting or securing financial compensation for at least one vaccine, whereby financial risk to at least one producer of vaccine and or other healthcare industry participant is reduced.

4. The vaccine reservation system according to claim 1 further including:
a preferably substantially automated means for parsing said electronic database to establish the quantities and types of vaccines to be distributed to a particular location for subsequent administration.

5. The vaccine reservation system according to claim 1 further including:
a preferably substantially automated means for informing the vaccine consumer or optionally a representative thereof of the availability of vaccine for administration.

6. The vaccine reservation system according to claim 1 further including:
a preferably substantially automated means for enabling the vaccine consumer or optionally a representative thereof to establish a specific appointment for the administration of said vaccine.

7. The vaccine reservation system according to claim 1 further including:
a preferably substantially automated means for enabling the vaccine consumer to report the consumer's physical response to said vaccine.

8. The vaccine reservation system according to claim 1 further including:
a preferably substantially automated means for allowing individuals or other benefactors to charitably gift one or more vaccines to those in need of vaccine.

9. The vaccine reservation system according to claim 1 further including:
a preferably substantially automated means for registering individuals in need of and optionally authorized to receive one or more vaccines via charitable gift.

10. The vaccine reservation system according to claim 1 further including:
a preferably substantially automated means for planning or managing personal vaccinations.

11. A method of substantially guaranteeing individual consumer access to at least one dose of vaccine using a substantially automated, consumer-driven, vaccine reservation system comprising the steps of:
providing at least one electronic database suitably configured to receive, store, and process vaccine reservations;
providing at least one electronic computer system suitably configured for hosting said electronic database;
providing at least one human interface means for enabling vaccine reservation information to be input to or output from said electronic database system;
operating said electronic database, said electronic computer system, and said human interface means to reserve at least one vaccine.
whereby said vaccine reservation system enables a vaccine consumer to reserve at least one vaccine to substantially guarantee said consumer access to the reserved vaccine.

12. The method according to claim 11, further including the additional steps of:
providing a preferably substantially automated means for summing the number of reserved vaccines contained with said electronic database, whereby the sum of reserved vaccines is available to at least one vaccine producer as an aid for determining vaccine production quantity; and
operating said means to provide the sum of reserved vaccines to at least one vaccine producer.

13. The method according to claim 11, further including the additional steps of:
providing a preferably substantially automated means for accepting or securing financial compensation for at least one vaccine, whereby financial risk to at least one producer of vaccine or other healthcare industry participant is reduced; and
operating said means to secure financial payment.

14. The method according to claim 11, further including the additional steps of:
providing a preferably substantially automated means for parsing said electronic database to establish the quantities and optionally types of vaccines to be distributed to a particular location for subsequent administration; and
operating said means to establish the quantities and optionally types of vaccines to be distributed to a particular location for subsequent administration.

15. The method according to claim 11, further including the additional steps of:
providing a preferably substantially automated means for informing the vaccine consumer or optionally a representative thereof of the availability of vaccine for administration; and
operating said means to inform the vaccine consumer or optionally a representative thereof of the availability of vaccine for administration.

16. The method according to claim 11, further including the additional steps of:
providing a preferably substantially automated means for enabling the vaccine consumer or optionally a representative thereof to establish a specific appointment for the administration of said vaccine; and
operating said means to establish a specific appointment for the administration of said vaccine.

17. The method according to claim 11, further including the additional steps of:
providing a preferably substantially automated means for enabling the vaccine consumer to report the consumer's physical response to said vaccine; and
operating said means to report the consumer's physical response to said vaccine.

18. The method according to claim 11, further including the additional steps of:
providing a preferably substantially automated means for allowing individuals or other benefactors to charitably gift one or more vaccines to those in need of vaccine; and
operating said means to charitably gift one or more vaccines.

19. The method according to claim 11, further including the additional steps of:
providing a preferably substantially automated means for registering individuals in need of and optionally authorized to receive one or more vaccines via charitable gift; and
operating said means to register one or more individuals in need of vaccine.

20. The method according to claim 11, further including the additional steps of:
providing a preferably substantially automated means for planning or managing personal vaccinations; and
operating said means to plan or manage personal vaccinations.
